(19) United States
(12) Patent Application Publication
(10) Pub. No.: US 2025/0001564 A1
(43) Pub. Date: Jan. 2, 2025

(54) MACHINE AND METHOD FOR RUNNING A MACHINE

(71) Applicant: Hilti Aktiengesellschaft, Schaan (LI)

(72) Inventors: Matthias VON MONKIEWITSCH, Bregenz (AT); Stefan HAAG, Buchs (CH); Achim RUF, Feldkirch (AT); Horst NEUSS, Grabs (CH); Ran PLASCHKES, Kaufering (DE); Christoph STUERTZEL, Sigmarszell (DE); Andreas WETTSTEIN, Feldkirch (AT)

(21) Appl. No.: 18/693,005

(22) PCT Filed: Sep. 29, 2022
(86) PCT No.: PCT/EP2022/077119

§ 371 Date: Mar. 18, 2024

(30) Foreign Application Priority Data
Sep. 30, 2021 (EP) 21200249.7

(51) Int. Cl. B25B 23/147; E04F 13/08

(52) U.S. Cl. CPC B25B 23/147; E04F 13/0833

(57) ABSTRACT

A machine and a method for drilling a hole or setting a screw is provided, wherein the machine comprises a motor having a shaft and one or more magnetic coils, providing electric current to the one or more magnetic coils to rotationally drive the shaft, and switching the electric current at a commutation frequency to define a rotational speed of the shaft. A signal may be generated when a force towards the machine applied to the shaft increases and/or a torque applied to the shaft increases and the rotational speed of the motor may be increased to a first rotational speed when the signal is received. The rotational speed may be at least 6,800 RPM and at most 8,500 RPM.

### TECHNICAL FIELD

Described herein are machines and methods for running the machines to set screws. Also described are hand-held power tools for enabling screw-setting actions. Typically, such hand-held tools find a widespread use in the construction industry. A typical hand-held tool as intended to be covered by the scope of the present invention includes, but is not limited to, an automatic screw driver for screwing screw fasteners into a workpiece, thereby penetrating the workpiece, such as a drywall board and/or a metal frame, with a screw fastener.

### BACKGROUND ART

Hand-held power tools are known to enable setting actions of a screw. The tools comprise at least a machine housing including at least a motor that provides at least rotary motion to a rotary shaft. The rotary shaft, in turn, will ultimately transmit a certain torque at a certain rotational speed to a workpiece penetrating element, such as, for example, a screw fastener. A tool may also comprise a controller, for controlling the motor and continuously determining the delivered torque and rotational speed of the rotary shaft when the tool is in use.

One possible field of application is fastening drywall elements by self-tapping screws to a frame structure. Such work is usually done by professional construction workers who are used to press the screws against the drywall elements with a great force to work at a high repetition rate. Due to such a great force, a screw may be pressed through the drywall element so quickly that a thread cannot be formed in the drywall element, thus weakening a material of the drywall element and potentially impairing setting quality.

### SUMMARY

According to one aspect, a method for running a machine to set a screw along a setting axis into a workpiece, wherein the machine comprises a motor having a shaft and one or more magnetic coils, comprises providing electric current to the one or more magnetic coils to rotationally drive the shaft, switching the electric current at a commutation frequency to define a first rotational speed of the shaft, wherein the first rotational speed is at least 6,800 RPM, particularly at least 7,200 RPM, and at most 9,000 RPM, particularly at most 8,500 RPM. According to an embodiment, the machine comprises a magazine, and the method comprises transporting a number of screws, e.g. collated screws, one after another, in front of a drive bit driven by the shaft of the motor, and setting the screws, likewise one after another, into a workpiece.

According to another embodiment, the method comprises running the motor at an idle speed, continuously determining a torque applied to the shaft by the motor, and increasing the rotational speed of the motor from the idle speed to the first rotational speed when the torque exceeds a first threshold. Determining the torque applied to the shaft by the motor may comprise determining an amperage of the electric current provided to the motor. Throughout the present description, “continuously determining” is meant to include semi-continuous sampled measurements, with an appropriate sample rate, which the skilled person will know how to choose, depending on the application.

According to another embodiment, the method comprises increasing the rotational speed of the motor to the first rotational speed immediately after starting the motor.

According to another aspect, a method for fastening a drywall element to a frame structure comprises providing a machine which comprises a motor having a shaft, one or more magnetic coils, and a screwdriver bit driven by the shaft, providing a screw driven by the screwdriver bit and having a tip and a thread, wherein the thread defines a thread pitch, and running the machine to drive the screw through the drywall element into the frame structure, wherein running the machine comprises providing electric current to the one or more magnetic coils to rotationally drive the shaft, switching the electric current at a commutation frequency to define a first rotational speed of the shaft, wherein the first rotational speed is at least 6,800 RPM, particularly at least 7,200 RPM, and at most 9,000 RPM, particularly at most 8,500 RPM.

According to an embodiment, the thread pitch is at least 1.25 mm. According to another embodiment, the thread pitch is at most 3 mm.

According to another embodiment, the screw comprises a pointed tip.

According to another embodiment, the screw comprises a drill tip comprising one or more drilling edges.

According to another aspect, a machine for setting a screw along a setting axis into a workpiece comprises a motor having a shaft and one or more magnetic coils, a switch, a controller provided for providing electric current to the one or more magnetic coils to rotationally drive the shaft and switching the electric current at a commutation frequency to define a first rotational speed of the shaft, wherein the first rotational speed is at least 6,800 RPM, in particular at least 7,200 RPM, and at most 9,000 RPM, in particular at most 8,500 RPM. According to an embodiment, the machine comprises a magazine configured to transport a number of screws, e.g. collated screws, one after another, in front of a drive bit driven by the shaft of the motor.

According to an embodiment, the controller is provided for one or more of running the motor at an idle speed, continuously determining a torque applied to the shaft by the motor, determining an amperage of the electric current provided to the motor, increasing the rotational speed of the motor from the idle speed to the first rotational speed when the torque exceeds a first threshold, starting the motor, and increasing the rotational speed of the motor to the first rotational speed immediately after starting the motor.

According to another aspect, a method for running a machine to drill a hole and/or set a screw along a setting axis into a workpiece, wherein the machine comprises a motor having a shaft, comprises generating a first signal when a force towards the machine along the setting axis is applied, or increased, to the shaft and/or a torque around the setting axis is applied, or increased, to the shaft, and changing the rotational speed of the motor to a first rotational speed when the first signal is received.

According to an embodiment, the method comprises providing electric current to the motor to rotationally drive the shaft at an idle speed, and changing the rotational speed of the motor from the idle speed to the first rotational speed when the first signal is received. The method may further comprise continuously determining a torque applied to the shaft by the motor, and generating the first signal when the torque exceeds a first threshold. Determining the torque applied to the shaft by the motor may comprise determining an amperage of the electric current provided to the motor.

According to another embodiment, changing the rotational speed to the first rotational speed comprises increasing the rotational speed.

According to another embodiment, changing the rotational speed of the motor comprises starting the motor.

According to another embodiment, the method comprises generating a second signal when the motor is operated at the first rotational speed, and changing the rotational speed of the motor to a second rotational speed when the second signal is received. The method may further comprise generating the second signal when a torque around the setting axis applied to the shaft changes, or increases, or decreases. The method may further comprise continuously determining the torque applied to the shaft by the motor, and generating the second signal when the torque exceeds or falls below a second threshold. Determining the torque applied to the shaft by the motor may comprise determining an amperage of the electric current provided to the motor.

According to another embodiment, the method comprises generating the second signal when a predetermined time interval has lapsed after the first signal has been received.

According to another embodiment, changing the rotational speed to the second rotational speed comprises decreasing the rotational speed. The second rotational speed may be substantially equal to the idle speed.

According to another aspect, a machine for drilling a hole and/or setting a screw along a setting axis into a workpiece comprises a motor having a shaft, a switch, a controller provided for generating a first signal when a force towards the machine along the setting axis is applied to the shaft and/or a torque around the setting axis is applied to the shaft, and changing the rotational speed of the motor to a first rotational speed when the first signal is received.

According to an embodiment, the controller is further provided for one or more of providing electric current to the motor to rotationally drive the shaft at an idle speed, changing, or increasing, the rotational speed of the motor from the idle speed to the first rotational speed when the first signal is received, continuously determining a torque applied to the shaft by the motor, determining an amperage of the electric current provided to the motor, generating the first signal when the torque exceeds a first threshold, starting the motor, generating a second signal when the motor is operated at the first rotational speed, changing, or decreasing, the rotational speed of the motor to a second rotational speed when the second signal is received, generating the second signal when a torque around the setting axis applied to the shaft changes, generating the second signal when the torque exceeds a second threshold, and generating the second signal when a predetermined time interval has lapsed after the first signal has been received.

According to an embodiment, the machine comprises a press-on switch provided for generating a press-on signal when a force towards the machine along the setting axis is applied to the shaft. The controller may be provided for receiving the press-on signal and starting the motor upon receipt of the press-on signal.

### BRIEF DESCRIPTION OF THE DRAWINGS

Further aspects and advantages of the machine, associated parts and a method of use thereof will become apparent from the ensuing description that is given by way of example only and with reference to the accompanying drawings in which:

FIG. 1 shows a machine,

FIG. 2 shows a screw in a start position relative to a drywall,

FIG. 3 shows the screw of FIG. 2 in a first intermediate position,

FIG. 4 shows the screw of FIG. 2 in a second intermediate position,

FIG. 5 shows the screw of FIG. 2 in an end position,

FIG. 6 shows an exemplary characteristic of a distance traveled by a screw over time,

FIG. 7 shows another characteristic of a distance traveled by a screw over time,

FIG. 8 shows an exemplary characteristic of a rotational speed of a motor over time, and

FIG. 9 shows another characteristic of a rotational speed of a motor over time.

### DETAILED DESCRIPTION

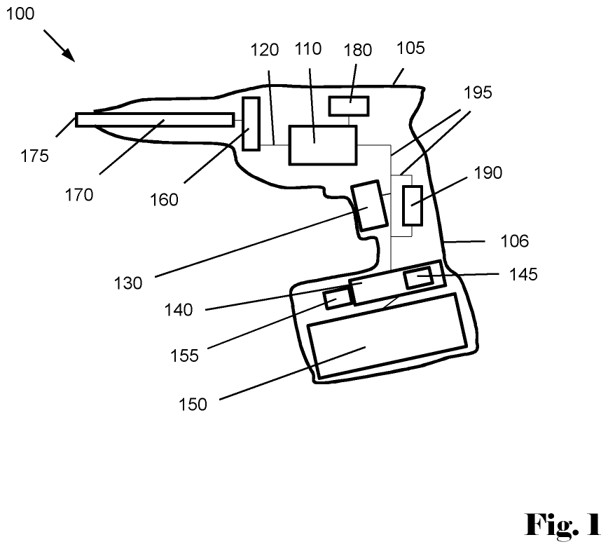

FIG. 1 shows a machine 100 for drilling a hole and/or setting a screw. In the embodiment shown, the machine 100 is formed as a hand-held working tool such as an automatic screwdriver. The machine 100 comprises a housing 105 and, enclosed by the housing 105, a motor 110 having a shaft 120, a switch 130 formed as a trigger switch, a controller 140 formed as a microcomputer and having a data storage 145 formed as a computer memory, a battery 150, and a communication unit 155 formed as a wireless transmitter. The controller 140 provides electric current from the battery 150 to the motor 110 to rotationally drive the shaft 120. The machine 100 further comprises a gear 160 and a spindle 170 having a screw drive 175 such as a hex drive and driven by the shaft 120 via the gear 160.

Further, the machine 100 comprises a rotational-speed sensor 180 for detecting a rotational speed of the motor 110 and an amperage/voltage sensor 190 for detecting an amperage and/or voltage of the electric current provided to the motor 110. Further, the machine 100 comprises lines 195 which connect the controller 140 with the motor 110, the switch 130 and sensors 180, 190 for transmitting electric current to the motor 110 and/or collecting electric signals from the switch 130 and/or sensors 180, 190. Additionally, or alternatively, to acquire data on the rotational speed, amperage or voltage of the motor 110, the controller 140 may use information already present from its controlling a rotational movement of the motor 110, for example the number of electrical commutations over time for the rotational speed. The housing 105 comprises a grip section 106 for manually gripping the machine 100 by a user such that the switch 130 can be pressed by the user's index finger. The switch 130 is capable of signaling its switch position to the controller 140 via the lines 195.

FIGS. 2-5 show a support 200, such as a rail or a console, having a support surface 201, a component 210, such as a drywall element, having a component surface 211 and intended to be fastened to the support element 200, and a fastening element 220, such as a screw, for fastening the component 210 to the support 200. In the embodiment shown, the fastening element has a shaft 221, a tip 222 and a head 223, wherein a thread 224 having a thread pitch is formed on the shaft 221. The tip 222 is formed as a pointed tip to chiplessly penetrate the support 200.

FIG. 2 shows the fastening element 220 in a start position relative to the support 200 in which the tip 222 of the fastening element 220 contacts the component surface 211 and begins to penetrate the component 210.

FIG. 3 shows the fastening element 220 in a first intermediate position relative to the support 200 in which the fastening element 220 has drilled through the component 210. The tip 222 of the fastening element 220 contacts the support surface 201 and begins to penetrate the support 200.

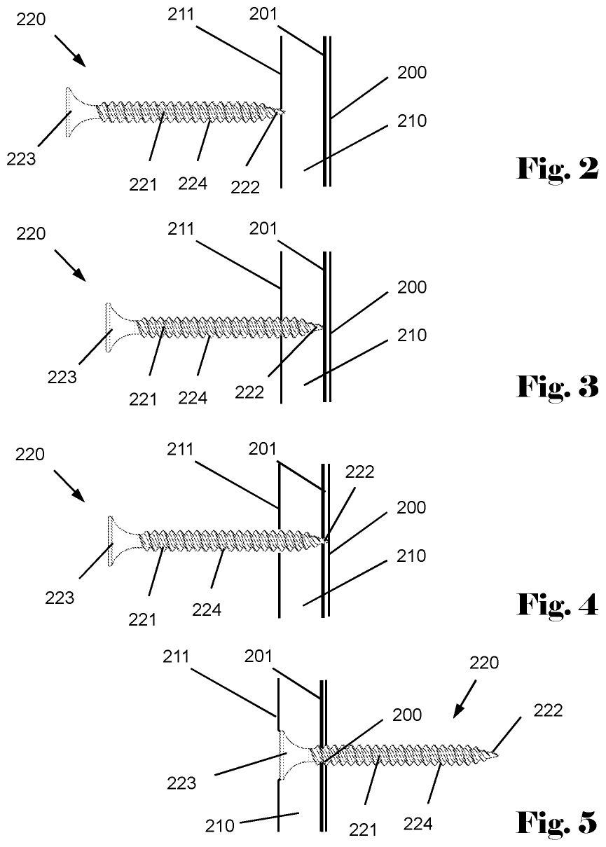

FIG. 4 shows the fastening element 220 in a second intermediate position relative to the support 200 in which the tip 222 of the fastening element 220 has pierced the support 200.

FIG. 5 shows the fastening element 220 in an end position relative to the support 200 in which the fastening element 220 has drilled through the support 200 and the thread 224 has tapped a counter thread into the support 200. The head 223 has been pushed into the component 210 and ends flush with the component surface 211 or slightly below the component surface 221 in order to avoid any protruding from the component surface 211. In the end position, the fastening element 220 presses the component 210 against the support 200 and holds the component 210 in place.

FIG. 6 shows a characteristic 300 of a distance traveled by a fastening element, such as the fastening element 220 shown in FIGS. 2-5, during a fastening process over time. The fastening element travels from a start position 310, corresponding to the position of the fastening element 220 shown in FIG. 2, via a first intermediate position 320 and a second intermediate position 330, corresponding to the first and second intermediate positions of the fastening element 220 shown in FIGS. 3 and 4, respectively, to an end position 340, corresponding to the end position of the fastening element 220 shown in FIG. 5.

The fastening element is driven by a machine for setting a screw, such as the machine shown in FIG. 1, at a rotational speed. The characteristic 300 comprises a first graph 350 for a fastening element driven at a first rotational speed of 5,000 RPM (rounds per minute), and a second graph 360 for the same fastening element driven at a second rotational speed of 7,500 RPM. Further, a first reference graph 370, corresponding to a maximum moving speed of a slow worker using the machine, and a second reference graph 380, corresponding to a maximum moving speed of a fast worker using the machine, are shown each as a dotted line.

Investigations have shown that a trained worker tend to adjust their working speed to minimize their working effort, based on their experience, in particular when working with a magazine and collated screws. Experienced workers adjust their style of working to the tool over a certain time period to minimize their efforts and, eventually, any fatiguing effects, thus even overcompensating for a larger weight of the motor brought along with a relatively large rotational speed of at least 7,200 RPM, or even 7,500 RPM, at an adequate torque.

As can be seen in FIG. 6, penetrating and drilling through the component 210 (the phase between the start position 310 and the first intermediate position 320) and screwing the fastening element through the support (the phase between the second intermediate position 330 and the end position 340) take significantly less time for the second graph 360 (at 7,500 RPM) than for the first graph 350 (at 5,000 RPM). The time saving during penetrating and drilling through the support (the phase between the first intermediate position 320 and the second intermediate position 330) is also present, however, less significant. It is advantageous to drive the fastening element at a rotational speed of at least 7,500 RPM.

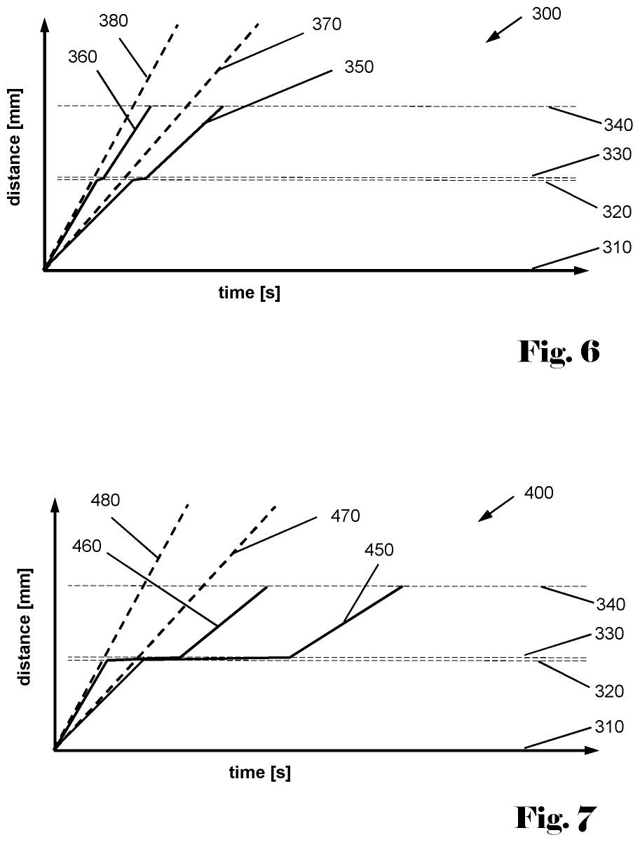

FIG. 7 shows a characteristic 400 of a distance traveled by a fastening element having a drill tip (not shown), in comparison to the fastening element 220 shown in FIGS. 2-5, during a fastening process over time. The characteristic 400 comprises a first graph 450 for a fastening element driven at a first rotational speed of 5,000 RPM, and a second graph 460 for the same fastening element driven at a second rotational speed of 7,500 RPM. Further, a first reference graph 470, corresponding to the maximum moving speed of a slow worker using the machine, and a second reference graph 480, corresponding to the maximum moving speed of a fast worker using the machine, are shown each as a dotted line.

As can be seen in FIG. 7, penetrating and drilling through the support (the phase between the first intermediate position 320 and the second intermediate position 330) takes significantly less time for the second graph 360 (at 7,500 RPM) than for the first graph 350 (at 5,000 RPM). The time saving during penetrating and drilling through the component 210 (the phase between the start position 310 and the first intermediate position 320) and screwing the fastening element through the support (the phase between the second intermediate position 330 and the end position 340) are also present, however, less significant. It is advantageous to drive the fastening element at a rotational speed of at least 7,500 RPM.

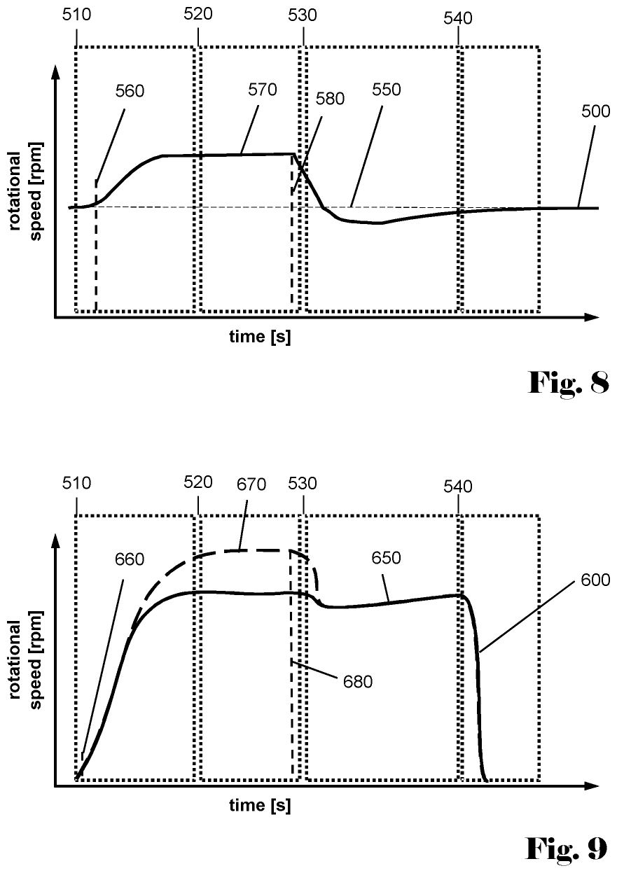

FIG. 8 shows a characteristic 500 of a rotational speed of a motor, such as the motor 110 shown in FIG. 1, during a fastening process, such as the fastening process shown in FIGS. 2-5, over time. The fastening element travels from a start position 510, corresponding to the position of the fastening element 220 shown in FIG. 2, via a first intermediate position 520 and a second intermediate position 530, corresponding to the first and second intermediate positions of the fastening element 220 shown in FIGS. 3 and 4, respectively, to an end position 540, corresponding to the end position of the fastening element 220 shown in FIG. 5.

In the embodiment shown, the motor runs at an idle speed 550 when the machine is in the start position 510. When the controller receives a first signal 560 when a force towards the machine along the setting axis is applied to the shaft and/or a torque around the setting axis is applied to the shaft, the controller increases the rotational speed of the motor to a first rotational speed 570. To this end, the machine may comprise a signal generator, such as a sensor, provided for generating the first signal upon detecting a force towards the machine along the setting axis and/or a torque around the setting axis. Additionally, or alternatively, the controller may be provided for generating the first signal upon recognizing a force towards the machine along the setting axis and/or a torque around the setting axis.

After a predetermined time interval has lapsed after the first signal 560 has been received, a second signal 580 is generated. When the controller receives the second signal 580, the controller decreases the rotational speed of the motor to the idle speed 550. In this way, less time is consumed for the overall setting process, whereas the rotational speed is optimized for each phase of the setting process. For a user of the machine, the setting process may be less exhaustive. At a rotational speed of more than 9,000 RPM, however, a fastening element may travel faster than even a fast worker moves the machine, thus disengaging from the machine, or a driving bit of the machine. Such a disengagement may result in an incomplete fastening process or setting failures. In some circumstances, e.g. for a less experienced worker, it is advantageous to drive the fastening element at a rotational speed of at most 8,500 RPM.

FIG. 9 shows a characteristic 600 of a rotational speed of a motor, such as the motor 110 shown in FIG. 1, during a fastening process, such as the fastening process shown in FIGS. 2-5, over time. In difference to FIG. 8, the motor does not move when the machine is in the start position 510. When the controller receives a first signal 560 when a force towards the machine along the setting axis is applied to the shaft, the controller starts the motor to a first rotational speed 670. After a predetermined time interval has lapsed after the first signal 660 has been received, a second signal 680 is generated. When the controller receives the second signal 680, the controller decreases the rotational speed of the motor to a second rotational speed 650. When the fastening process is finished, the controller stops the motor.

Throughout the present application, “current provided to the motor” is meant to include current that is measured within a power supply, such as a battery, if the hand-held power tool is a battery-operated tool.

The foregoing description of exemplary embodiments of the invention have been presented for purposes of illustration and of description. It is not intended to be exhaustive or to limit the invention to the precise form disclosed, and modifications and variations are possible in light of the above teachings or may be acquired from practice of the invention. The functionality described may be distributed among modules that differ in number and distribution of functionality from those described herein. Additionally, the order of execution of the functions may be changed depending on the embodiment. The embodiments were chosen and described in order to explain the principles of the invention and as practical applications of the invention to enable one skilled in the art to utilize the invention in various embodiments and with various modifications as suited to the particular use contemplated. It is intended that the scope of the invention be defined by the claims appended hereto and their equivalents.

1. A method for running a machine to set a screw along a setting axis into a workpiece, wherein the machine comprises a motor having a shaft and one or more magnetic coils, the method comprising:
providing electric current to the one or more magnetic coils to rotationally drive the shaft;
switching the electric current at a commutation frequency to define a first rotational speed of the shaft;
wherein the first rotational speed is at least 6,800 RPM and at most 8,500 RPM.

2. The method according to claim 1, further comprising:
running the motor at an idle speed;
continuously determining a torque applied to the shaft by the motor;
increasing the rotational speed of the motor from the idle speed to the first rotational speed when the torque exceeds a first threshold.

3. A method according to claim 2, wherein determining the torque applied to the shaft by the motor comprises determining an amperage of the electric current provided to the motor.

4. A method according to claim 1, further comprising:
increasing the rotational speed of the motor to the first rotational speed immediately after starting the motor.

5. A method for fastening a drywall element to a frame structure, the method comprising:
providing a machine comprising a motor having a shaft and one or more magnetic coils, the machine further comprising a screwdriver bit driven by the shaft;
providing a screw driven by the screwdriver bit and having a tip and a thread, the thread defining a thread pitch;
running the machine by the method according to claim 1 to drive the screw through the drywall element into the frame structure.

6. A method according to claim 5, wherein the thread pitch is at least 1.25 mm.

7. A method according to claim 5, wherein the thread pitch is at most 3 mm.

8. A method according to claim 5, wherein the screw comprises a pointed tip.

9. A method according to claim 5, wherein the screw comprises a drill tip comprising one or more drilling edges.

10. A machine for setting a screw along a setting axis into a workpiece, comprising:
a motor having a shaft and one or more magnetic coils;
a switch;
a controller provided for providing electric current to the one or more magnetic coils to rotationally drive the shaft and switching the electric current at a commutation frequency to define a first rotational speed of the shaft;
wherein the first rotational speed is at least 6,800 RPM and at most 8,500 RPM.

11. The machine according to claim 10, wherein the controller is further provided for one or more of:
running the motor at an idle speed;
continuously determining a torque applied to the shaft by the motor;
determining an amperage of the electric current provided to the motor;
increasing the rotational speed of the motor from the idle speed to the first rotational speed when the torque exceeds a first threshold;
starting the motor;
increasing the rotational speed of the motor to the first rotational speed immediately after starting the motor.

12. The method for fastening a drywall element to a frame structure, the method comprising:
providing a machine comprising a motor having a shaft and one or more magnetic coils, the machine further comprising a screwdriver bit driven by the shaft;
providing a screw driven by the screwdriver bit and having a tip and a thread, the thread defining a thread pitch;
running the machine by the method according to claim 2 to drive the screw through the drywall element into the frame structure.

13. The method according to claim 12, wherein the thread pitch is at least 1.25 mm.

14. The method according to claim 6, wherein the thread pitch is at most 3 mm.

15. The method according to claim 6, wherein the screw comprises a pointed tip.

16. The method according to claim 6, wherein the screw comprises a drill tip comprising one or more drilling edges.

17. The method for fastening a drywall element to a frame structure, the method comprising:
providing a machine comprising a motor having a shaft and one or more magnetic coils, the machine further comprising a screwdriver bit driven by the shaft;
providing a screw driven by the screwdriver bit and having a tip and a thread, the thread defining a thread pitch;
running the machine by the method according to claim 3 to drive the screw through the drywall element into the frame structure.

18. The method for fastening a drywall element to a frame structure, the method comprising:
providing a machine comprising a motor having a shaft and one or more magnetic coils, the machine further comprising a screwdriver bit driven by the shaft;
providing a screw driven by the screwdriver bit and having a tip and a thread, the thread defining a thread pitch;
running the machine by the method according to claim 4 to drive the screw through the drywall element into the frame structure.

19. The method according to claim 7, wherein the screw comprises a pointed tip.

20. The method according to claim 7, wherein the screw comprises a drill tip comprising one or more drilling edges.
